(19) United States
(12) Patent Application Publication
(10) Pub. No.: US 2024/0170757 A1
(43) Pub. Date: May 23, 2024

(54) Battery pack as an energy source for electrical consumers

(71) Applicant: Andreas Stihl AG & Co. KG, Waiblingen (DE)

(72) Inventors: Maria Pöhler, Waiblingen (DE); Andreas Wolf, Leutenbach (DE); Alexander Härtel, Ludwigsburg (DE); Jürgen Glaser, Lug (DE); Andreas Henzler, Unterensingen (DE)

(73) Assignee: Andreas Stihl AG & Co. KG, Waiblingen (DE)

(21) Appl. No.: 18/509,655

(22) Filed: Nov. 15, 2023

(30) Foreign Application Priority Data
Nov. 17, 2022 (EP) 22208185.3

(51) Int. Cl. H01M 10/653; H01M 10/48; H01M 10/613; H01M 10/647; H01M 10/6551; H01M 50/105; H01M 50/211; H01M 50/293; H01M 50/296; H01M 50/298

(52) U.S. Cl. CPC H01M 10/653; H01M 10/482; H01M 10/613; H01M 10/647; H01M 10/6551; H01M 50/105; H01M 50/211; H01M 50/293; H01M 50/296; H01M 50/298

(57) ABSTRACT

A battery pack has a closed housing with an inner receiving space for several battery cells. The housing has a general basic shape with first and second side walls. The side walls of the housing are made of a heat-conducting material. The inner surfaces of the side walls limit the receiving space. In order to create a thermally balanced battery pack, a cell assembly including several battery cells is accommodated in the receiving space. A battery cell has flat sides and edge sides. The battery cells lie with their flat sides stacked next to each other such that there are outer battery cells and inner battery cells. The outer battery cells rest with their flat sides in a flat and heat-transferring manner against the inner surfaces of the first side walls of the housing, and the inner battery cells are heat-transferring to the outer battery cells of the cell assembly.

### CROSS-REFERENCE TO RELATED APPLICATION

This application claims the benefit of European Patent Application EP22208185.3, filed on Nov. 17, 2022, the contents of which is incorporated in its entirety.

### SUMMARY

The disclosure relates to a battery pack as an energy source for an electrical consumer. The battery pack has a closed housing that has a general basic shape with first and second side walls. The housing can additionally have a first end face and a second end face. At least the side walls of the housing are made of a heat-conducting material. A material is considered to be heat-conducting if its thermal conductivity exceeds 10 W/mK. The inner surfaces of the side walls delimit an inner receiving space of the housing in which several rechargeable battery cells are arranged. Cooling fins of the housing are formed on the outer surfaces of the side walls facing away from the receiving space.

In order to provide a powerful, small-sized battery pack, several battery cells are arranged close together in the housing's receiving space. While the battery pack is in use by an external consumer, the temperature of the battery cells rises. Inner battery cells that are surrounded by outer battery cells are subject to greater thermal stress than the outer battery cells. The internal temperature of the battery pack increases from the outside to the inside. An excessive increase in the internal temperature of a battery pack can lead to a premature safety shutdown, even though there is still sufficient battery capacity available to operate an electrical consumer for a longer period of time.

The disclosure is based on the object of designing a battery pack as an energy source for an electrical consumer in such a way that, even under heavy electrical load, the temperature of inner battery cells of the battery pack does not rise significantly more than the temperature of outer battery cells. The aim is to create a battery pack that is thermally balanced under load.

The object is achieved in that a cell assembly consisting of several battery cells is accommodated in the receiving space, with a battery cell having flat sides and edge sides. In particular, the battery cells are designed as pouch cells (coffee bag cells). The flat side of a battery cell advantageously corresponds to the inner surface of a side wall of the housing. The cell assembly arranged in the receiving space comprises several battery cells stacked next to each other with their flat sides. The cell assembly has outer battery cells that abut only one adjacent battery cell. Inner battery cells are located on the inside of the battery pack and sandwiched between two adjacent battery cells. The outer battery cells of the cell assembly rest with their flat sides against the inner surfaces of the first side walls of the housing to transfer heat. The inner battery cells lie on the facing flat sides of the outer battery cells of the cell assembly to transfer heat.

The heat generated in the outer battery cells is transferred directly to the side wall of the housing, so that the outer battery cell forms a kind of heat sink in the cell assembly. The waste heat from an inner battery cell lying flat on the outer battery cell is transferred to the housing via the outer battery cell, which forms a heat sink. Thermal overloading of inner battery cells can thus be avoided. The cell assembly is thermally balanced.

In order to further improve the heat dissipation of inner battery cells, it is provided that the battery cells of the cell assembly rest with their edge sides against the inner surfaces of the second side walls of the housing in a heat-transferring manner. In this way, in addition to the heat-dissipating heat path via the outer battery cells, the inner battery cells have direct contact with the side wall of the housing, which consists of a heat-conducting material.

Rechargeable battery cells, in particular pouch cells, are subject to a change in volume depending on their state of charge, which must be considered when the receiving space is tightly filled with battery cells. In a further development, it is therefore provided to arrange a volume compensation element between adjacent battery cells of the cell assembly. The volume compensation element includes, in particular, heat-conducting material. The volume compensation element has a height and a width that corresponds to the dimensions of a battery cell, in particular a pouch cell. The volume compensation element is arranged in the cell assembly after two, three, four or more battery cells. It may be sufficient to arrange one or two volume compensation elements in a cell assembly of, for example, ten battery cells.

For good heat dissipation from the receiving space via the heat-dissipating first and second side walls of the housing, several battery cells of the cell assembly lie flat against one another. In particular, the battery cells directly abut each other.

The packing density of the cell assembly in the receiving space is selected such that the receiving space is preferably filled to 95% to 98%. It is advantageous to fill the receiving space completely, in particular to fill it completely with battery cells and in particular at least one volume compensation element that may be necessary. The cell assembly is arranged in such a way that heat is dissipated onto the heat-dissipating housing of the battery pack via both the first side walls and the second side walls.

To avoid a heat hotspot in the center of the cell assembly, it may be advantageous to connect the second side walls of the housing to one another via at least one inner, heat-conducting partition wall. The partition wall extends over the height and width of a flat side of a battery cell. The receiving space is divided into at least two sub-spaces by the partition wall. A subassembly of battery cells is accommodated in each subspace, with the cell assembly of the battery pack being composed of at least two subassemblies.

In a further development of the invention, a cable channel designed as a recess in the side wall is provided on the inner surface of a side wall. The cable channel lies outside the receiving space delimited by the inner surfaces of the side walls of the housing. The electrical lines required within a battery pack between the battery contacts on one end face of the housing and operating and/or display elements on the other end face of the housing can be placed in the cable channel without disturbing the close contact or abutment of the flat side of an outer battery cell to the inner surface of the side wall of the housing. The cable channel preferably extends from the first end face of the housing to the second end face of the housing. The cable channel extends in particular in the vertical direction of the housing.

The cable channel is designed so that it is closed to the receiving space. This can be achieved by filling the cable channel with a filling material, in particular a heat-conducting filling material. The filling level of the filling material lies parallel to the side wall, preferably in a plane with the inner surface of the side wall. Alternatively, it can also be provided to close the cable channel with a channel cover, the channel cover being made in particular of a heat-conducting material. The channel cover is arranged such that it lies in a plane with the inner surface of the side wall of the housing.

For good heat dissipation, longitudinal ribs are provided on the outer surface of a side wall of the housing. The longitudinal ribs run in particular in the vertical direction from one end face of the housing to the other end face of the housing. The longitudinal ribs increase the heat-emitting outer surface of the housing. The cable channel is designed with a depth measured perpendicular to the side wall, which is equal to or less than a rib height of a longitudinal rib measured perpendicular to the side wall.

The housing of the battery pack is designed such that a first end face of the housing is provided as the connection side of the battery pack. The first end face has battery contacts for charging or discharging the cell assembly. An electronic monitoring device for the cell assembly is arranged near the second end face of the housing, with electrical lines leading from the battery contacts to the monitoring device being routed in the cable channel.

The housing of the battery pack essentially consists of housing components for the side walls and a face component for each end face. The housing components for the side walls may be identical parts with each identical part comprising a first side wall and a second side wall of the battery pack. The base body of the battery pack consists of two housing components. The face components extend in particular over the edges of the side walls or the housing components. In particular, the edges of the side walls or the housing components engage in a circumferential sealing groove of a face component.

In a further development it is provided that longitudinal ribs running in the vertical direction are provided on the outer surface of a side wall of the housing. Two adjacent longitudinal ribs on a side wall of the housing delimit a longitudinal groove which opens into a face component of an end face. The design is expediently provided in such a way that the mouth of a first longitudinal groove opening into a face component forms a sprue opening for a potting material and the mouth of a second longitudinal groove opening into the same face component forms a vent opening. After assembling the housing and placing a face component, potting material can be injected into the interior space via an outer longitudinal groove, for example to completely encapsulate the monitoring device provided near a face component. The air displaced during potting can escape via the second longitudinal channel.

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

FIG. 1 is an overall perspective view of a battery pack,

FIG. 2 is a side view of the battery pack according to FIG. 1,

FIG. 3 shows a housing component of the housing of the battery pack consisting of an angle component made of a first side wall and a second side wall,

FIG. 4 shows another side view of the battery pack according to FIG. 1,

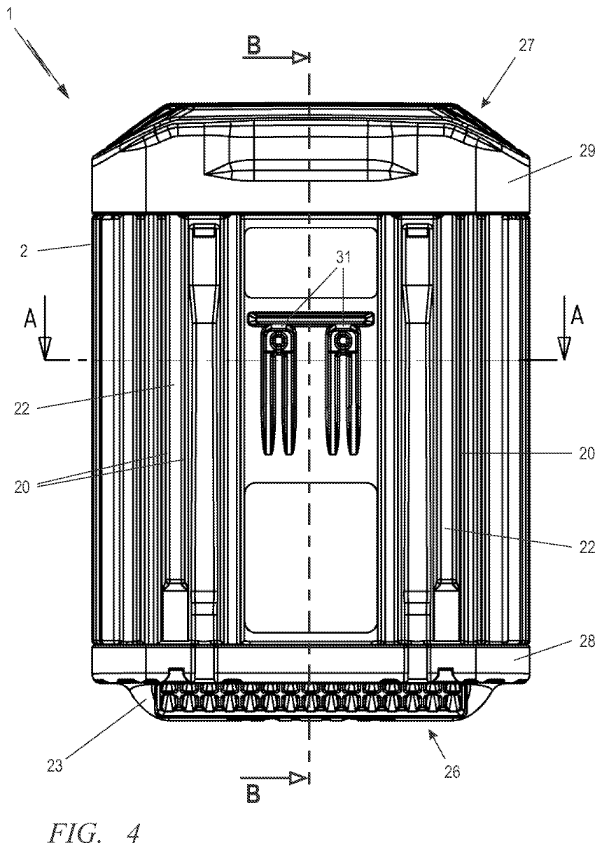

FIG. 5 shows a section through the battery pack along line A-A in FIG. 4,

FIG. 6 shows a section through the battery pack along line B-B in FIG. 4,

FIG. 7 is a perspective view of a battery cell of the battery pack in an embodiment as a pouch cell.

### DETAILED DESCRIPTION

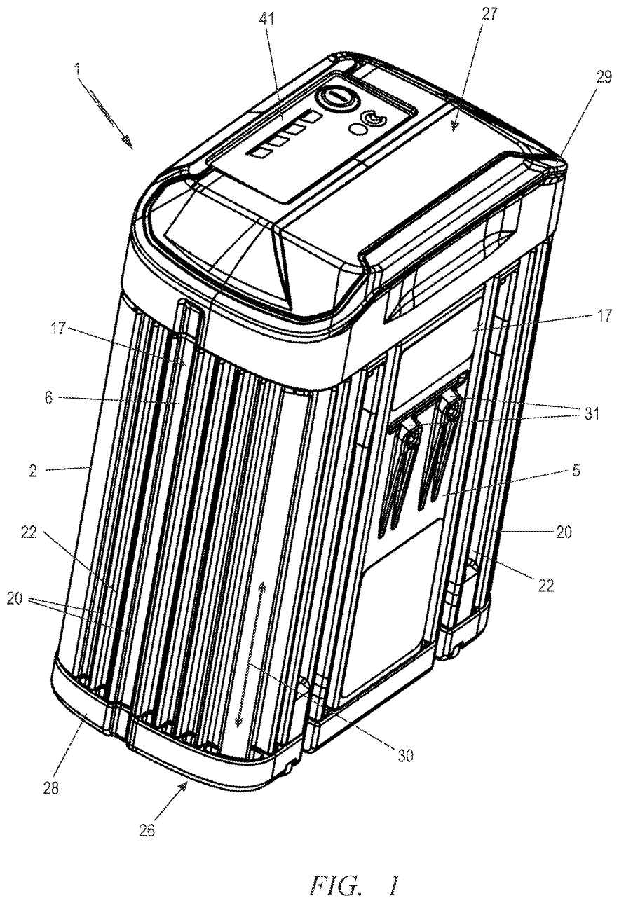

The battery pack 1 shown in FIG. 1 serves as an energy source for an electrical consumer such as a handheld work apparatus, in particular a handheld work apparatus that is carried during operation. Such a work apparatus can be a chainsaw, a brushcutter, a blower, a hedge trimmer or similar work apparatus.

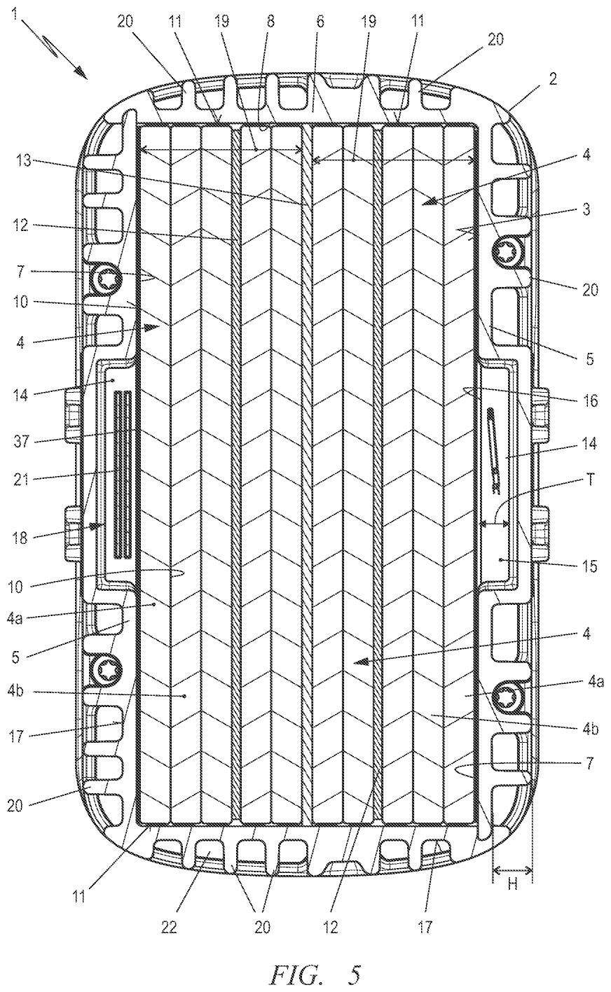

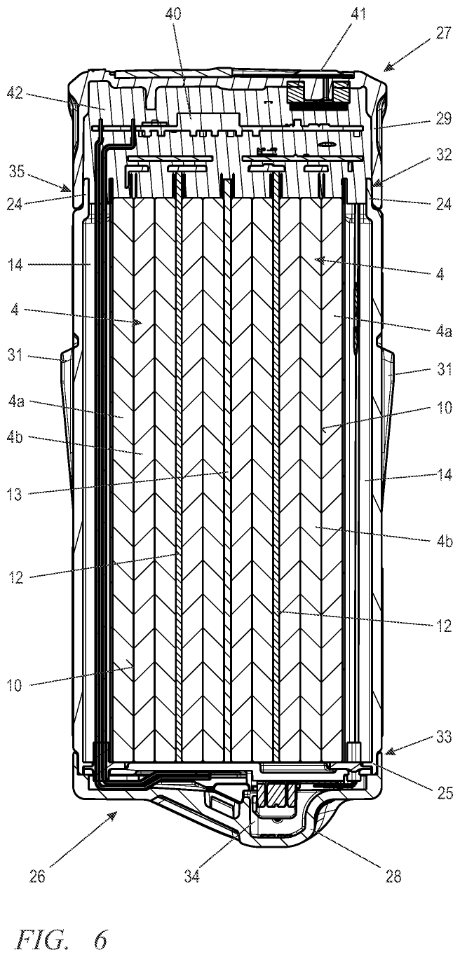

The battery pack 1 has a closed housing 2 with an inner receiving space 3 (FIG. 5) in which a plurality of battery cells 4 are arranged, as shown in FIGS. 5 and 6.

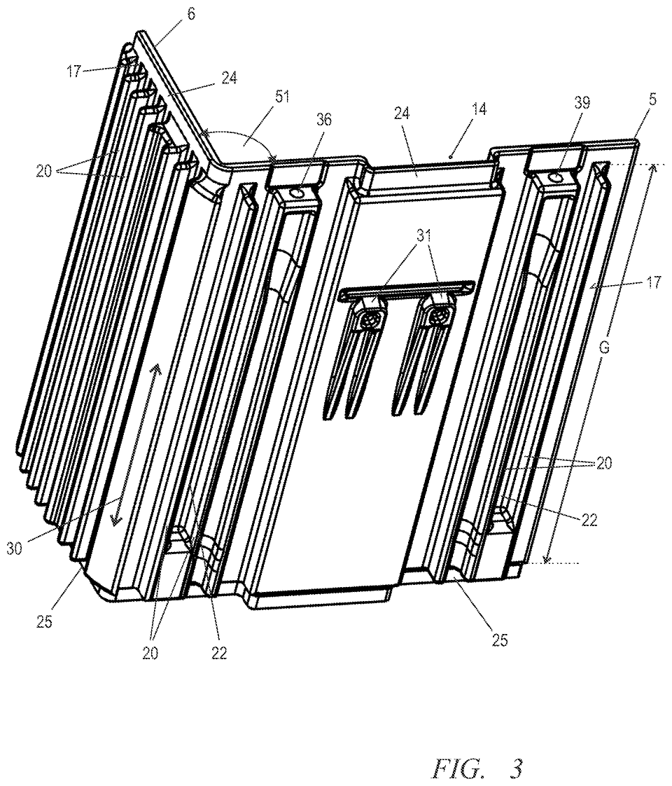

The housing 2 has a basic shape with first side walls 5 and second side walls 6. As shown in particular in FIG. 3, a first side wall 5 and a second side wall 6 are formed on a common housing component 50 of the housing 2. The side walls 5 and 6 are arranged at a right angle 49 to one another. The housing component 50 thus forms an angle component. The side wall 5 forms a broad side of the housing 2; the side wall 6 forms a narrow side of the housing 2. The housing 2 has an essentially cuboid basic shape.

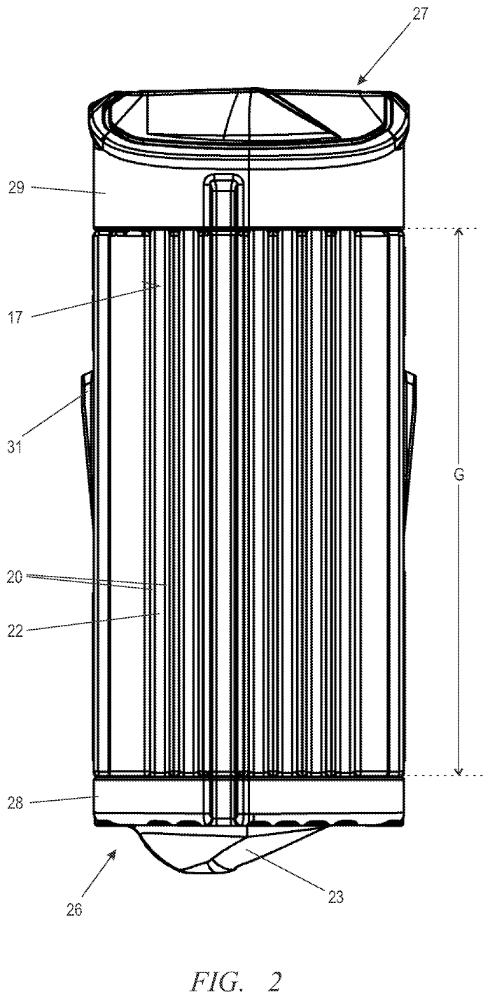

The housing 2 of the battery pack 1 further includes a first end face 26 and a second end face 27. The first end face 26 is formed by a first face component 28. The second end face 27 is formed by a second face component 29. The housing 2 is composed of the housing components 50, which are designed as identical parts, and the face components 28 and 29. The face components 28 and 29 overlap the side walls 5 and 6, as shown in particular in FIGS. 1 and 2. In particular, the edges 24 and 25 of the side walls 5 and 6 (see FIG. 3) are overlapped by the face components 28 and 29. To achieve a sealed housing, the edges 24 and 25 engage sealingly in a circumferential sealing groove 32 and 33 (FIG. 6) of a respective face component 28 and 29.

Longitudinal ribs 20 are formed on the outer surface 17 of the first side wall 5 and/or on the outer surface 17 of the second side wall 6 of the housing 2. The longitudinal ribs 20 run in particular in the vertical direction 30 of the housing 2. The longitudinal ribs 20 extend essentially over the entire height G of the side wall, each side wall 5, 6 being formed with an upper edge 24 and a lower edge 26. Locking elements 31 are provided on the side wall 5 forming the broad side of the battery pack 1. The locking elements 31 serve to lock the battery pack 1 in a receiving slot of a work apparatus.

FIG. 3, in particular, shows longitudinal ribs 20, which run directly next to one another and run in the vertical direction 30, and which delimit a longitudinal groove 22 on the outer surface 17 of a side wall 5, 6. A longitudinal groove 22 formed between two adjacent longitudinal ribs 20 opens into a face component 28 or 29 of an end face 26 or 27 of the battery pack 1. In a special embodiment, it is provided that the mouth 36 of a first longitudinal groove 22 forms a sprue opening for a potting material and the mouth 39 of a second longitudinal groove 22 forms a vent opening. This creates the possibility of potting existing cavities in the face components 28 and 29 with insulating material after the housing 2 has been assembled from the housing components 50 and the face components 28 and 29. For example, an electronic monitoring device 40 arranged in the second face component 29 can be completely encapsulated by potting. The potting material can also penetrate into the sealing groove 32 or 33 and establish a mechanically strong connection between the face component 28 or 29 and the housing components 50.

As can be seen in particular from FIG. 6, the first end face 26 of the battery pack 1 is designed as a connection side of the battery pack. In the connection side of the battery pack 1, electrical battery contacts 34 are provided for charging or discharging a cell assembly accommodated in the battery pack 1.

In the second end face 27 of the battery pack 1, a display device 41 is provided. The display device 41 may indicate a charge status of the battery pack 1. Control elements can also be integrated into the display device 41.

FIG. 6 shows that the second face component 29 serves, on the one hand, to accommodate the display device 41 and, on the other hand, to accommodate a monitoring device 40, which is used to electrically monitor the cell assembly, the temperature within the cell assembly and the charging and discharging current. FIG. 6 also shows that the cell contacts 35 of the battery cells of the cell assembly located in the face component 29 are covered with the potting material 42, whereby a mechanical stabilization of the cell contacts 35 is achieved.

As can be seen from the section through the battery pack 1 along the line A-A in the illustration according to FIG. 5, several battery cells 4 are accommodated in the receiving space 3 of the housing 2. A plurality of battery cells 4 forms a cell assembly 19. FIG. 5 shows two cell subassemblies 19, which together form the cell assembly of the battery pack 1.

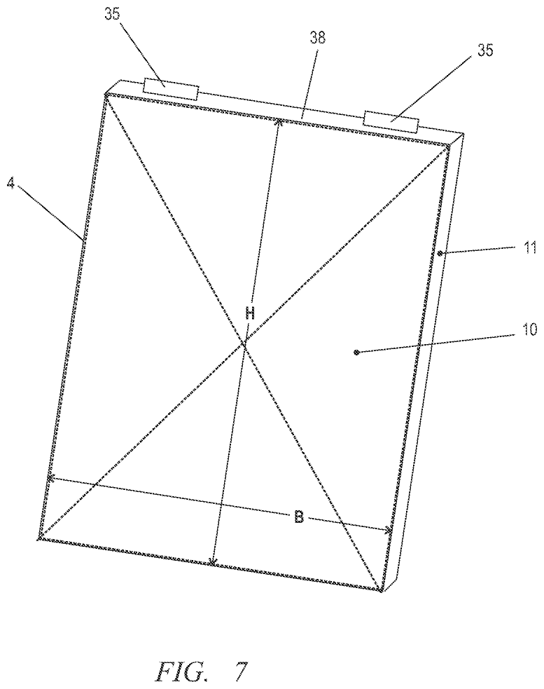

In the exemplary embodiment illustrated schematically in FIG. 7, a pouch cell (coffee bag cell) is shown as a battery cell 4. The battery cell 4 has flat sides 10 and edge sides 11. A flat side 10 has a height H and a width B. The electrical cell contacts 35 of the battery cell 4 are provided in an upper edge 38.

A battery cell 4 has a cell voltage of 3.6 to 4.2 V.

A total of ten battery cells 4 are arranged in the receiving space 3 of the housing 2 delimited by the inner surfaces 7 and 8 of the side walls 5 and 6. The battery pack 1 therefore has a nominal voltage of 36 V.

A cell assembly 19 is formed from several battery cells 4 stacked next to one another, layered with their abutting flat sides 10. A cell assembly 19 has external, outer battery cells 4a and internal, inner battery cells 4b. FIG. 5 shows the outer battery cells 4a of the cell assembly 19 resting with their flat sides 10 on the inner surfaces 7 of the first side walls 5 of the housing 2 in a flat and heat-transferring manner. An inner battery cell 4b rests with its flat side 10 flat against the flat side of the adjacent outer battery cell 4a. The outer battery cell 4a transfers heat directly to the side wall 5 of the housing 2, so that the outer battery cell forms a kind of heat sink. The heat passed on from the inner battery cell 4b via the flat side contact with the outer battery cell 4a is transferred via the outer battery cell 4a to the side wall of the housing.

It is advantageously provided that the battery cells 4 of the cell assembly 19 rest with their edge sides 11 on the inner surfaces 8 of the second side walls 6 of the housing 2 in a heat-transferring manner. This is particularly advantageous for the inner battery cells 4b. An inner battery cell 4b transfers generated heat directly to the heat-conducting housing 2 of the battery pack 1 via the surface contact of its edge sides 11 with both narrow sides of the housing 2, i.e. with both second side walls 6 of the housing 2. Internal battery cells 4b can also safely release process heat that occurs in this way, so that excessively high temperatures inside the cell assembly 19 are reliably avoided.

Since the outer battery cells 4a also rest with their edge sides 11 on the second side walls of the housing 2, their functioning as a heat sink is guaranteed.

The cell assembly 19 fills at least 95% of the receiving space 3. The cell assembly 19 may fill the receiving space completely. As a result, regardless of the state of charge or discharge of the battery pack 1, good heat-transferring contact is achieved between both the flat sides 10 of a battery cell 4 and the edge sides 11 of a battery cell 4 on the heat-dissipating material of the side walls 5 and 6. A thermally balanced battery pack 1 is achieved.

To compensate for volume fluctuations of a cell assembly 19 formed in particular from pouch cells, a volume compensation element 12 can advantageously be provided. In order to improve the heat transport within the cell assembly, it is provided that the volume compensation element 12 comprises a heat-conducting material, in particular consists of a heat-conducting material.

It may be advantageous to divide the receiving space 3 by an inner partition wall 13. FIGS. 5 and 6 show the at least one inner, heat-conducting partition wall 13 being arranged such that it connects the second side walls 6 of the housing 2 to one another. The second side walls 6 are the narrow sides of the housing 2. The receiving space 3 is divided into two parts by the heat-conducting, inner partition wall 13. A cell subassembly 19 is accommodated in each subspace.

The inner partition wall 13 can be inserted as a component into the receiving space 3. The partition wall 13 is advantageously part of the housing 2, in particular provided in one piece with the housing 2.

FIGS. 5 and 6 show a cable channel 18 designed as a recess 14 provided on the inner surface 7 of a side wall 5. The recess 14 or the cable channel 18 formed thereby lies outside the receiving space 3 delimited by the inner surfaces 7 and 8 of the side walls 5 and 6 of the housing 2. The cable channel 18 extends in the vertical direction 30 of the housing 2 from the first end face 26 to the second end face 27 of the housing 2. The ends of the cable channel 18 are—as shown in FIG. 6—open to the first face component 28 and/or to the second face component 29. Electrical lines 21 routed in the cable channel 18 can be connected to the battery contacts 34 on the one side and to the monitoring device 40 on the other side. Preferably, a recess 14 is formed as a cable channel 18 in each first side wall 5, which in particular form the broad sides of the housing 2 of the battery pack 1.

As FIG. 5 shows, the cable channel 18 is designed to be closed towards the receiving space 3. In a first embodiment, the cable channel 18 can be closed with a filling material 15 after electrical cables have been inserted. A filling level 16 of the filling material 15 lies in particular in a plane with the inner surface 7 of the first side wall 5. It can also be useful to close the cable channel 18 with a channel cover 37. The channel cover 37 closes the recess 14 in such a way that it lies in a plane with the inner surface 7 of the first side wall 5.

The recess 14 of the cable channel 18 has a depth T measured perpendicular to the side wall 5, which is equal to or less than the rib height H of a longitudinal rib 20 measured perpendicular to the side wall. The base of the recess 14 therefore does not protrude beyond the outer contour of the housing 2 to the outside.

What is claimed is:

1. A battery pack being an energy source for an electrical consumer, comprising:
a closed housing (2) with a receiving space (3) for several battery cells (4), the closed housing (2) comprising side walls (5, 6) including
first side walls (5) and
second side walls (6); and
a cell assembly (19) comprising several battery cells (4) accommodated in the receiving space (3),
wherein the side walls (5, 6) consist of a heat-conducting material,
wherein inner surfaces (7, 8) of the side walls (5, 6) delimit the receiving space (3),
wherein cooling fins (20) are formed on outer surfaces (9) of the side walls (5, 6) facing away from the receiving space (3),
wherein each of the battery cells (4) has flat sides (10) and edge sides (11),
wherein the several battery cells (4) of the cell assembly (19) are stacked next to one another with their flat sides (10) whereby the cell assembly (19) includes outer battery cells (4a) and inner battery cells (4b),
wherein the outer battery cells (4a) of the cell assembly (19) rest flatly and heat-transferring with their flat sides (10) on the inner surfaces (7) of the first side walls (5), and
wherein the inner battery cells (4b) are connected to the outer battery cells (4a) of the cell assembly (19) in a heat-transferring manner.

2. The battery pack according to claim 1,
wherein the battery cells (4) of the cell assembly (19) rest with their edge sides (11) in a heat-transferring manner on the inner surfaces (8) of the second side walls (6).

3. The battery pack according to claim 1, further comprising
a volume compensation element (12) arranged between adjacent battery cells (4) of the cell assembly (19).

4. The battery pack according to claim 3,
wherein the volume compensation element (12) comprises a heat-conducting material.

5. The battery pack according to claim 1,
wherein the several battery cells (4) of the cell assembly (19) lie flat against one another.

6. The battery pack according to claim 1,
wherein the several battery cells (4) of the cell assembly (19) directly abut one another.

7. The battery pack according to claim 1,
wherein the cell assembly (19) fills at least 95% of the receiving space (3) and rests against the side walls (5, 6) in a heat-transferring manner.

8. The battery pack according to claim 1,
wherein the cell assembly (19) completely fills the receiving space (3).

9. The battery pack according to claim 1,
wherein the second side walls (6) are connected to one another by at least one inner, heat-conducting partition wall (13),
whereby the receiving space (3) is divided by the at least one inner, heat-conducting partition wall (13) into at least two sub-spaces, in each of which a cell subassembly (9) is arranged.

10. The battery pack according to claim 1, further comprising
a cable channel (18) in form of a recess (14) in one of the side walls (5, 6),
the cable channel (18) being arranged outside of the receiving space (3).

11. The battery pack according to claim 10,
wherein the housing (2) has a first end face (26) and a second end face (27), and
wherein the cable channel (18) extends from the first end face (26) to the second end face (27).

12. The battery pack according to claim 11,
wherein the cable channel (18) extends in a vertical direction (30) of the housing (2) from the first end face (26) to the second end face (27).

13. The battery pack according to claim 10,
wherein the cable channel (18) is closed towards the receiving space (3).

14. The battery pack according to claim 13,
wherein the cable channel (18) is filled with a filling material (15) and a filling level (16) of the filling material (15) extends parallel to one of the first side walls (5) and in a plane with the inner surface (7) of the one of the first side walls (5), or
wherein the cable channel (18) is closed with a channel cover (37) the channel cover (37) being arranged in a plane with the inner surface (7) of the one of the first side walls (5).

15. The battery pack according to claim 10,
wherein the cooling fins (20) are longitudinal ribs (20) running in a vertical direction (30) of the housing (2), and
wherein the cable channel (18) has a measured depth (T) perpendicular to the one of the side walls (5, 6) that is equal to or less than a rib height (H) of one of the longitudinal ribs (20) measured perpendicular to the one of the side walls (5, 6).

16. The battery pack according to claim 11,
wherein the first end face (26) of the housing (2) is designed as a connection side of the battery pack (1), in which electrical battery contacts (23) for charging or discharging the cell assembly (19) are provided, and
wherein an electronic monitoring device (40) for the cell assembly (19) is arranged in an area of the second end face (27) of the housing (2), and
wherein electrical lines (21) leading from the electrical battery contacts (23) to the electronic monitoring device (40) are guided in the cable channel (18).

17. The battery pack according to claim 1,
wherein the housing (2) of the battery pack (1) is composed of housing components (50) for the side walls (5, 6) and one face component (28, 29) for each end face (26, 27),
wherein each face component (28, 29) engages over edges (24, 25) of the side walls (5, 6) and/or wherein edges (24, 25) of the side walls (5, 6) engage in a sealing groove (32, 33) of the respective face component (28, 29).

18. The battery pack according to claim 17,
wherein the sealing groove (32, 33) is a circumferential sealing groove (32, 33).

19. The battery pack according to claim 1,
wherein longitudinal ribs (20) running in a vertical direction (30) are provided on an outer surface (17) of one of the side walls (5, 6) of the housing (2), and
wherein at least one longitudinal groove (22) formed on the one of the side walls (5, 6) between two longitudinal ribs (20) opens into a face component (28, 29) of an end face (26, 27).

20. The battery pack according to claim 19,
wherein the at least one longitudinal groove (22) include a first longitudinal groove (22) and a second longitudinal groove (22), and
wherein a mouth (36) of the first longitudinal groove (22) forms a sprue opening for a potting material (42), and a mouth (39) of the second longitudinal groove (22) forms a vent opening.
